(19) United States
(12) Patent Application Publication
(10) Pub. No.: US 2008/0288593 A1
(43) Pub. Date: Nov. 20, 2008

(54) Method and Apparatus for Creating Merged Mails

(75) Inventor: Michael Quade, Bonn (DE)

Correspondence Address: JACKIE JAY SCHWARTZ, 1350 Broadway, Suite 1510, NEW YORK, NY, 10018, US

(73) Assignee: T. MOBILE INTERNATIONAL AG & CO. KG, Bonn (DE)

(21) Appl. No.: 11/571,042

(22) PCT Filed: Apr. 19, 2006
(86) PCT No.: PCT/EP2006/061674

§ 371 Date: Dec. 20, 2006

(30) Foreign Application Priority Data
Apr. 20, 2005 (DE) 10 2005 018 401.4

(51) Int. Cl. G06F 13/00

(52) U.S. Cl. 709/206

(57) ABSTRACT

A method for creating merged mails (1a-1c) of a sender (4) to a number of predetermined addressees (5), in particular including information or advertising content (6), wherein, in each merged mail (1a-1c), a directions information (7) is inserted for finding the sender (4), wherein the directions information (7) is calculated in an addressee-specific manner for each merged mail (1a-1c) with respect to the address of each addressee (5) and the address of the sender (4).

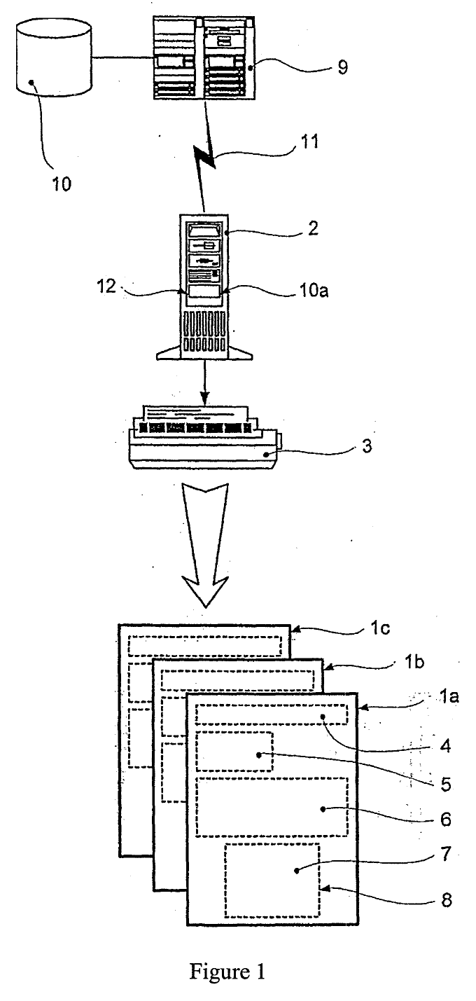

The present invention relates to a method and an apparatus for creating merged mails of a sender to a number of predetermined addressees, in particular containing information or advertising content, wherein each merged mail includes a directions information for finding the sender. The present invention also relates to an associated computer program product and a data carrier therefor.

It is common, especially for advertising purposes and for providing information to customers to contact existing or potential customers in the form of merged mails. For the addressee of the merged mail to be able to visit the sender in their offices, for example, to seek consulting or maintenance services or to get to know or buy goods, it has proven advantageous to provide the merged mail with directions either in the form of an imprint or of an inserted information sheet.

As is generally known, such directions are created by software locally utilized by a user on a computer (PC) or by using internet applications. The directions contain textual indications for certain sections of a route and/or a graphical map representation of the route, wherein the address of the sender is graphically highlighted. Merged mails of the type of interest here are created with the aid of address data corresponding to a customer list or a list of interested persons, and then sent to the addressees. Herein, the address can include a certain person or simply a street address or the like.

A drawback of this prior art method for creating merged mails for the purpose of interest here, results from the fact that, in the merged mails or the inserted information sheets, the geographic position of the sender, such as its offices, is only shown as a rough map. The town or city of residence of the addressee of the merged mail is not indicated. This is why such directions which can be classified as “target maps” presume that the addressee of the merged mail has a certain local knowledge. Addressees without local knowledge, however, are only insufficiently addressed by such a merged mail, so that the advertising message contained, if any, is only insufficiently transported. For addressees without local knowledge, moreover, the distance between their place of residence and the sender of the merged mail can only be estimated with difficulty.

It is therefore an object of the present invention to develop a method and an apparatus for creating merged mails of the generic type in such a way that directions information with a higher content of information can be represented.

On the basis of a method according to the preamble of claim 1, the object is solved in conjunction with its characterizing features. In view of a corresponding apparatus, the object is solved by claim 5. Claim 13 indicates an associated computer program product, which can be implemented in the form of a data carrier according to claim 14.

The present invention incorporates the process-related teaching that the directions information is calculated for each merged mail in a customer-specific manner with respect to the address of each addressee stored in an addressee database and the address of the sender, so that each merged mail contains directions information relevant to each individual addressee.

The advantage of the approach according to the present invention is that finding of the sender, in particular for addressees unfamiliar with the localities, is substantially facilitated. The merged mails provided with directions according to the present invention are therefore qualitatively better able to transport any included advertising messages.

The directions information to be included in the merged mails can be created according to two alternative method steps. On the one hand, it is suggested that the directions information be calculated by way of data-technical preprocessing prior to creating the merged mails, and for this to be made available for the creation of the merged mails together with the addresses of the addressees of interest. As an alternative, it is also conceivable, however, that the directions information to be included in the merged mails is calculated as the merged mails are created, which is done on the basis of the available addresses of the addressees. In this variant, the creation of the directions information is therefore in real time together with the addresses to be processed in one data processing step to create the merged mails. For the second alternative, a longer creation period for the merged mails must be reckoned with due to the high computing overhead.

Preferably the addresses of the addressees of interest for the merged mails are retrieved from a special address database which is queried with customer-specific criteria by the sender. Such customer-specific criteria can be derived from a customer profile, which contains the customer's habits or preferred products.

According to a further embodiment it is advantageously provided that the address of the addressee is specified to a particular person, a household, a particular street or a particular place. It is thus possible by correspondingly preselecting the address specification prior to the creation of the merged mails to create person-specific merged mails, mail shots and the like.

If the sender of a merged mail is an enterprise with a network of branches, it is suggested in the context of the present invention as a further improvement, that the address of the sender is specified to that branch of the sender's firm or institution which is closest to the addressee. This is how the addressee of the merged mail gets directions information which leads him or her to the most conveniently situated branch office.

The directions information in the context of the present invention can be both in the form of a text or a graphic representation, preferably a schematic map, and can be programmed as a mail merge field into the merged mail. A textual directions information contains descriptions of a sequence of partial sections of the route, which eventually lead to the sender of the merged mail as a target location. This textual information can be represented, however, in a clear form, in the form of a schematic map.

The above described method can be particularly easily implemented by means of a software controlled computer, which drives a printer for printing the merged mails. The routine for creating the directions information is implemented by control commands stored in the software. This software can be provided on the one hand on a data carrier, such as a CD-ROM, wherein it is also conceivable to only provide an address database on the data carrier. On the other hand it is also possible, however, to make the address database and/or the routine for creating the directions information available on a central service server which is connected to the local computer of a user creating the merged mails via a data telecommunications link. A printer connected to this local computer then creates the merged mails with the directions information according to the present invention.

Further measures improving upon the present invention are presented together with the description of a preferred exemplary embodiment of the invention with reference to the single FIGURE.

The FIGURE shows an apparatus for creating merged mails by means of a local computer coupled to a service server.

According to the FIGURE, an apparatus for creating mail merges 1a-1c comprises a local computer 2, with which a printer 3 is connected for printing merged mails 1a-1c. Each merged mail 1a-1c includes the address of a sender 4, a predetermined addressee 5, an information or advertising content 6 with a graphical directions information 7 in the text portion. Directions information 7 is for enabling the sender 4 of merged mails 1a-1c to be found. Directions information 7 of each merged mail 1a-1c is created in an addressee-specific manner with respect to the address of each addressee 5 and the address of the fixed sender 4 for each merged mail 1a-1c. To do this, each merged mail 1a-1c includes a mail merge field 8 with the graphical directions information 7 contained in it.

As a means of inserting directions information 7 in merged mails 1a-1c, software controlled computer 2 is used. Computer 2 accesses a remote central service server 9. Central service server 9 is in communication with an address database 10 in which addressees 5 of merged mails 1a-1c, in question, are stored. Service server 9, in this exemplary embodiment also carries out the creation of directions information 7 by means of corresponding software. A data telecommunications link 11 is between local computer 2 and central service server 9. Local computer 2 queries the mail merge information required for the creation of merged mails 1a-1c, comprising directions information 7 according to the present invention, via data telecommunications link 11, in order to process this information in a data-processing process for creating merged mails 1a-1c, which are then output to printer 3.

In parallel or as an alternative to the above described online variant of the apparatus according to the present invention, the information storage and/or information processing can also be carried out directly on local computer 2, wherein the routine for creating directions information 7, in the present case, is available on a storage medium 12 of local computer 2. In this case, an address database 10a will also be stored on storage medium 12.

### LIST OF REFERENCE NUMERALS

1 Merged mail
2 Local computer
3 Printer
4 Sender
5 Addressee
6 Information or advertising content
7 Directions information
8 Mail merge field
9 Service server
10 Address database
11 Data communications link
12 Storage medium

1. A method for creating merged mails of a sender to a number of predetermined addressees, in particular including information or advertising content, wherein a directions information for finding the sender is included in each merged mail, wherein the directions information is calculated for each merged mail in an addressee-specific manner with respect to the address of each addressee and the address of the sender.

2. The method according to claim 1,
wherein the directions information to be included in the merged mails is calculated prior to the creation of the merged mails in a preprocessing step and is made available for creating the merged mails together with the addresses of the addressees.

3. The method according to claim 1,
wherein the directions information to be included in the merged mails is calculated as the merged mails are created, which is done on the basis of addresses of the addressees made available.

4. The method according to claim 1,
wherein the addresses of the addressees are retrieved from an address database, which is queried according to customer-specific criteria specified by the sender.

5. An apparatus for creating merged mails of a sender to a number of predetermined addressees, in particular including information or advertising content, comprising means for inserting directions information for finding the sender in each merged mail,
wherein the means for inserting the directions information carry out an addressee-specific calculation for each merged mail with respect to the address of each addressee and the address of the sender.

6. The apparatus according to claim 5,
wherein the address of the addressee is specified to a particular person, a particular household, a particular street or a particular place.

7. The apparatus according to claim 5,
wherein the address of the sender is specified to a branch office of the sender firm or institution which is closest to the addressee.

8. The apparatus according to claim 5,
wherein the directions information is in the form of text or graphics, and is included in the merged mail as a mail merge field.

9. The apparatus according to claim 5,
wherein the means for inserting the directions information is configured as a software controlled computer.

10. The apparatus according to claim 9,
wherein the address database and the routine for creating the directions information is made available on a central services server, which is linked to the local computer of a user creating the merged mails via a data communications link.

11. The apparatus according to claim 9,
wherein the routine for creating the directions information is made available on a storage medium of the computer creating the merged mails.

12. The apparatus according to claim 11,
wherein the associated address database is also stored on the storage medium.

13. A computer program product for an apparatus according to claim 5, wherein the routine for creating the directions information is implemented by corresponding control commands stored in a software.

14. A data carrier comprising a computer program product according to claim 13.
